(19) United States
(12) Patent Application Publication
(10) Pub. No.: US 2022/0075206 A1
(43) Pub. Date: Mar. 10, 2022

(54) FIXING DEVICE FOR SPECTACLES FRAME

(71) Applicant: F & H, Lyon (FR)

(72) Inventor: Sébastien Brusset, Fontaines-Sur-Saône (FR)

(73) Assignee: F & H, LYON (FR)

(21) Appl. No.: 17/466,747

(22) Filed: Sep. 3, 2021

(30) Foreign Application Priority Data
Sep. 4, 2020 (FR) FR2009011

(51) Int. Cl. G02C 5/22

(52) U.S. Cl. CPC G02C 5/22; G02C 2200/02

(57) ABSTRACT

A fixing device for a spectacles frame is disclosed that includes: a first element comprising a first opening, the first element, being magnetized, a second element comprising a second opening, the second element being a magnetic element, and a connecting element housed in the first opening and in the second opening so as to mechanically connect the first element to the second element, the connecting element being a magnetic element.

The present application claims priority to French patent application number FR2009011, filed Sep. 4, 2020, the entire disclosure of which is incorporated herein by reference.

The invention relates to a fixing device for a spectacles frame. The invention also relates to a spectacles frame comprising at least one such fixing device. The invention additionally relates to a pair of spectacles comprising such a spectacles frame and/or at least one such fixing device. The invention likewise relates to a method for assembling or fitting such a fixing device. The invention finally relates to a method for removing such a fixing device.

A pair of spectacles generally comprises a spectacles frame generally comprising a frame front notably able to accept two lenses. The spectacles frame also comprises two temple arms. Each temple arm is fixed by a fixing means on each side of the frame front. Notably in order to limit the bulkiness of the pair of spectacles when not in use, the fixing means connecting each temple arm to the frame front is of the hinge type. This allows the two temple arms to be “unfolded” in order to use the pair of spectacles and allows the two temple arms to be “folded” and brought substantially into contact with the frame front in all other cases. In general, this hinge is a clevis system, the axis of pivoting of the clevis being embodied by a screw. For the sake of aesthetics, of limiting the bulkiness and mass of such a hinge, the screw is very small in diameter and very short in length. This results in weakness that presents problems with reliability over time, notably with the screw working itself loose. If the screw becomes completely unscrewed, the temple arm becomes detached from the frame front, rendering the pair of spectacles unusable. Furthermore, given the size of the screw, complete unscrewing of the screw often results in the screw being lost. Finally, the forces resisting the movements of the temple arms are not lasting and vary considerably over the course of time.

Finally, there is a certain complexity involved in assembling the temple arms on the frame front of a spectacles frame whatever the nature of the components being assembled.

It is an object of the invention to provide a device for fixing a temple arm to a frame front of a spectacles frame that overcomes the abovementioned disadvantages and improves on the fixing devices known from the prior art. In particular, the invention makes it possible to achieve a connection between a temple arm and a frame front of a spectacles frame that is simple, discrete and reliable, while at the same time being able to be dismantled.

According to the invention, the fixing device for a spectacles frame comprises:

a first element comprising a first opening, the first element being magnetized,

a second element comprising a second opening, the second element being a magnetic element, and

a connecting element housed in the first opening and in the second opening so as to mechanically connect the first element to the second element, the connecting element being a magnetic element.

The fixing device may be a hinge, it being possible for the connecting element to be a cylindrical or substantially cylindrical shaft and/or it being possible for the first and second openings to be cylindrical or substantially cylindrical orifices so as to allow the first element to pivot relative to the second element.

The first element may comprise a permanent magnet or may be a permanent magnet.

The first element may have an annular shape, notably the shape of an annulus of revolution.

The connecting element may be a permanent magnet.

The first element may be a frame-front element of a spectacles frame and the second element may be a temple-arm element of a spectacles frame.

The first element may be a temple-arm element of a spectacles frame and the second element may be a frame-front element of a spectacles frame.

According to the invention, a spectacles frame comprises a frame front and at least one temple arm, the at least one temple arm being mechanically connected to the frame front by a fixing device defined hereinabove.

According to the invention, a pair of spectacles comprises:

a spectacles frame defined hereinabove, and/or

a fixing device defined hereinabove.

According to the invention, a method for assembling or fitting a fixing device defined hereinabove comprises the following steps:

placing the connecting element in the first element,

placing the second element against the first element, the connecting element moving into the second opening, under the effect of magnetic forces, when the second opening is positioned in front of or opposite the first opening.

According to the invention, a method for removing a fixing device defined hereinabove comprises the following steps:

placing a magnetic removal tool on the first element or near the first element so that, under the effect of magnetic forces, the connecting element moves out of the second element,

separating the first element from the second element.

The appended figures depict, by way of example, one embodiment of a fixing device according to the invention.

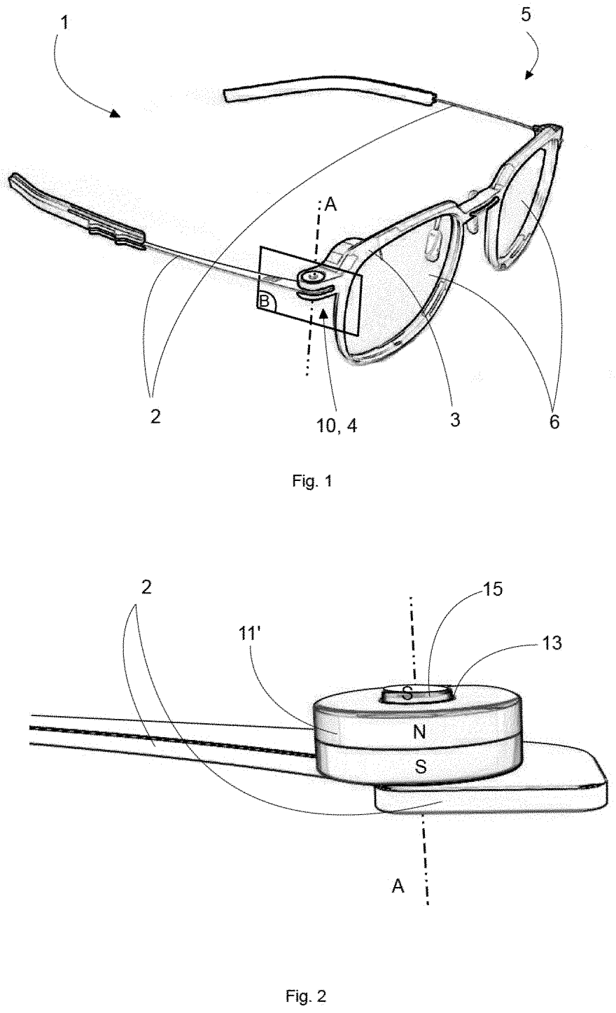

FIG. 1 is a perspective view of a pair of spectacles according to one embodiment.

FIG. 2 is a perspective view of a temple frame of a pair of spectacles, of a first element and of a connecting element of a fixing device according to one embodiment.

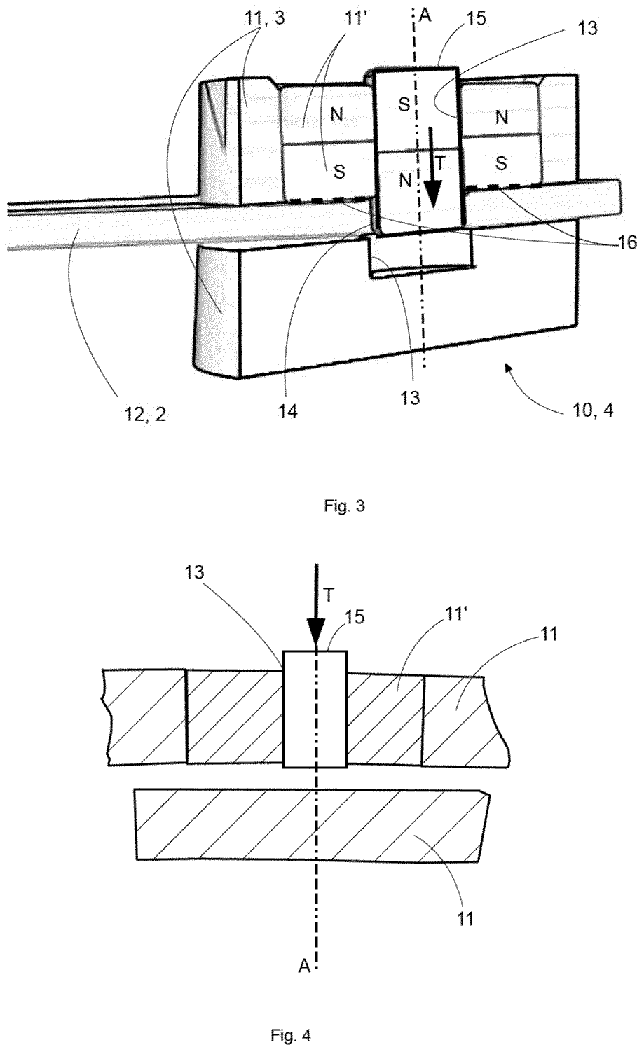

FIG. 3 is a view in section and in perspective of the fixing device according to the embodiment, the section being taken on a plane B passing through the axis A of the fixing device.

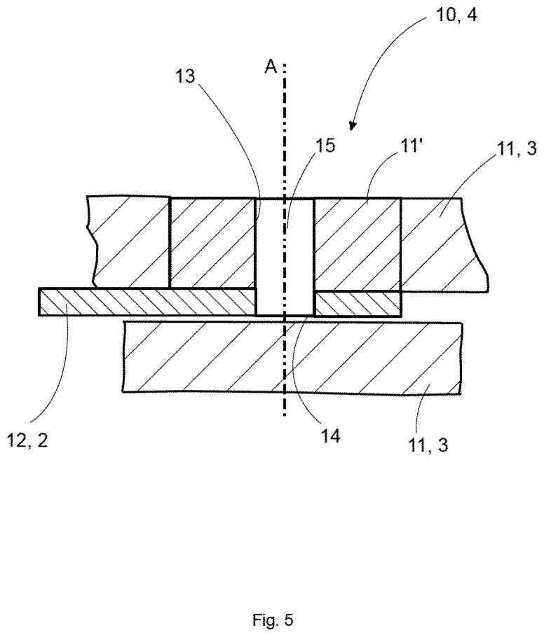

FIG. 4 is a schematic view in section on plane B of the first element and of the connecting element of the fixing device according to the embodiment.

FIG. 5 is a schematic view in section on the plane B of the fixing device according to the embodiment.

One embodiment of a pair of spectacles 1 is illustrated in FIG. 1. The pair of spectacles 1 comprises a spectacles frame 5. What is meant by “pair of spectacles” is the assembly of a spectacles frame 5 with two lenses 6. The pair of spectacles 1 or the spectacles frame 5 further comprises at least one temple arm 2 (or temple side), preferably two temple arms 2. The pair of spectacles 1 or the spectacles frame 5 also comprises a frame front 3. The frame front 3 is intended to position and/or support the lenses 6.

As illustrated in particular in FIG. 1, the pair of spectacles 1 or the spectacles frame 5 further comprises a fixing device 10 for fixing the temple arm 2 to the frame front 3. Thus, each temple arm 2 is mechanically connected to the frame front 3 by the fixing device 10.

More specifically, as illustrated in FIGS. 2 to 5, the fixing device 10 comprises a first element 11. The first element 11 comprises a first opening 13 of axis A. Advantageously, the first element 11 is magnetized.

The fixing device 10 further comprises a second element 12. The second element 12 comprises a second opening 14 of axis A. Advantageously, the second element 12 is a magnetic element.

As a preference, the first and second openings are coaxial or substantially coaxial.

The fixing device 10 further comprises a connecting element 15 housed in the first opening 13 and in the second opening 14. Thus, the connecting element 15 is able to mechanically connect the first element 11 to the second element 12.

Specifically, the connecting element in this configuration in which it is engaged in the first element and in the second element is able to transmit from one of the first and second elements to the other any load or any component of load perpendicular to the axis A. This makes it possible to lock any translational movement (perpendicular to the axis A) of the first element relative to the second element.

Advantageously, the connecting element 15 is a magnetic element.

As a preference, the fixing device 10 is a hinge 4. In other words, the connecting element 15 allows the first element 11 to pivot relative to the second element 12. Thus, advantageously, the connecting element is, for example, a cylindrical or substantially cylindrical shaft of axis A and/or the first and second openings 13, 14 are cylindrical or substantially cylindrical orifices with axes coincident or substantially coincident with the axis A. Advantageously, the diameters of the orifices 13, 14 and the diameter of the cylindrical shaft 15 are such that a clearance remains between the shaft and the orifices so as to allow the pivoting.

As a preference, a magnetic return force returning the first element 11 onto the second element 12 and the coefficient of friction of the first element 11 on the second element 12 allow a desired friction torque to be achieved. Specifically, the magnetized first element 11 creates a magnetic force that presses the second element against the first element.

The friction or contact zone 16, illustrated in dotted line in FIG. 3, may be defined according to the desired torque for the pivoting of the temple arm with respect to the frame front. In other words, the interface between the first element and the second element is defined according to the desired resistive torque. This definition may be obtained using dimensional parameters of the contact zone at the interface and/or parameters concerned with the surface finish and/or the nature of the materials of the contacting surfaces.

As illustrated in particular in FIG. 3, the first element 11 comprises, or is, a permanent magnet 11′. As a preference, as illustrated in FIGS. 2 and 3, the first element 11 has an annular shape, for example the shape of an annulus of revolution, for example having an axis of revolution coincident or substantially coincident with the axis A. In FIG. 3, the magnet is depicted with a North pole (N) at the top and a South pole (S) at the bottom.

For example, the connecting element 15 is a permanent magnet. In FIG. 3, the connecting element is depicted with a South pole (S) at the top and a North pole (N) at the bottom.

According to the embodiment illustrated, the first element 11 is an element of the frame front 3 of the spectacles frame 5. The second element 12 is then an element of the temple arm 2 of the spectacles frame 5. The first element may be part of the frame front 3 of the spectacles frame 5 or may be an element attached or fixed to the rest of the frame front, notably mounted tightly on the rest of the frame front or bonded to the rest of the frame front. The second element may be part of the temple arm 2 of the spectacles frame 5 or may be an element attached or fixed to the rest of the temple arm of the spectacles frame 5, notably mounted tightly on the rest of the temple arm of the spectacles frame 5 or bonded to the rest of the temple arm of the spectacles frame 5.

Alternatively, in a variant of the embodiment depicted, the first element is an element of the temple arm of the spectacles frame and the second element is an element of the frame front of the spectacles frame. The second element may be part of the frame front of the spectacles frame or may be an element attached or fixed to the rest of the frame front, notably mounted tightly on the rest of the frame front or bonded to the rest of the frame front. The first element may be part of the temple arm of the spectacles frame or may be an element attached or fixed to the rest of the temple arm of the spectacles frame, notably mounted tightly on the rest of the temple arm of the spectacles frame or bonded to the rest of the temple arm of the spectacles frame.

Alternatively, in another embodiment which has not been depicted, the connecting element has a polygonal, notably square, cross section and the first and second openings have similar polygonal, notably square, cross sections, so that the fixing device may produce or constitute a built-in connection or encastre connection between the first and second elements. The same may be achieved, even if the connecting element and/or the first and second elements have circular cross sections, if the first and second elements are connected by a slideway connection or by a pivot connection of axis parallel to the axis A and distant from the axis A prior to the fitting of the connecting element.

Alternatively, in yet another embodiment which has not been depicted, the fixing device is such that only the connecting element is magnetized or has permanent magnetization and the first and second elements are magnetic elements that do not have permanent magnetization. In other words, the first and second elements are of a nature such that they are attracted by a magnet. The connecting element is advantageously a magnet.

One way of implementing a method for assembling the fixing device is described hereinafter.

First of all, as illustrated in FIG. 4, the connecting element 15 is placed in the first element 11. In other words, the connecting element 15 is inserted into the first opening or bore 13 by effecting a translational or substantially translational movement, illustrated by an arrow T in FIG. 4. It is noteworthy to observe that, even in this state of partial fitting, the connecting element 15 is in a stable configuration which considerably limits the risks of an element of the fixing device becoming lost.

The second element 12 is then set in place against the first element 11 so as to align or substantially align the axis of the first opening 13 with the axis of the second opening 14. Under the effect of magnetic forces, the connecting element 15 moves, entering the second opening or bore 14, when the second opening 14 is positioned opposite or in front of the first opening 13. Thus, the various elements 11, 12, 13, 14, 15 are arranged in such a way that, under the effect of magnetic forces, the connecting element 15 moves, entering the second opening or bore 14, when the second opening 14 is positioned opposite or in front of the first opening 13.

Alternatively, in a first phase, the second element 12 is placed against the first element 11 so as to align or substantially align the axis of the first opening 13 with the axis of the second opening 14. The insertion of the connecting element 15 into the first opening 13 is begun. Under the effect of magnetic forces, the connecting element 15 moves, penetrating further into the first opening 13, then entering the second opening 14 as soon as the latter finds itself opposite or in front of the first opening 13. Specifically, as illustrated in particular in FIG. 3, if the element 11 comprises a permanent magnet 11′ and if at the same time the connecting element 15 is a permanent magnet and if also their N (North) and S (South) poles are oppositely arranged, the magnetic forces will cause the connecting element 15 to move in the direction of the arrow T, parallel or substantially parallel to the axis A.

At the end of the fitting method, in the case of a connecting element 15 and openings 13, 14 of the bore type, a fixing device of the pivot connection type of axis A or substantially of axis A is obtained. With the element 11 being, or being fixed to, a frame front of a spectacles frame, and the element 12 being, or being fixed to, a temple arm 2 of a spectacles frame, a pivot connection is obtained between the temple arm 2 and the frame front 3 of the frame. By providing one or more protuberances or stops or protrusions on the temple arm 2 and/or on the frame front 3, the pivoting amplitude is limited, preferably to an angle of around 90 degrees. Thus, a hinge of axis A or substantially of axis A is obtained.

Thus, the various elements 11, 12, 13, 14, 15 are arranged in such a is way that the magnetic forces are applied directly to the connecting element 15 and/or in such a way that the magnetic forces allow the connecting element 15 to move relative to the first and second elements. In other words, the various elements 11, 12, 13, 14, 15 are arranged in such a way that the connecting element 15 is able to move in the first and second elements, notably between a position of non-locking of a temple arm and a position of locking of this temple arm. In particular, the various elements 11, 12, 13, 14, 15 are arranged in such a way that, when the first and second openings are aligned, the magnetic forces act, notably act directly, on the connecting element 15 and move the connecting element 15, particularly moving it along the axis A, relative to the first and second elements. This movement preferably takes place with the first and second elements immobile or substantially immobile with respect to one another.

One implementation of a method for removing the fixing device is described hereinbelow.

First of all, a magnetic removal tool is placed on the first element 11 or near the first element 11. What is meant by a “removal tool” is a magnetized object, for example a magnet, or a magnetic object. Because of the effect of the magnetic forces between the removal tool and the connecting element 15, the connecting element 15 is attracted in the direction T, in the opposite sense to the arrow. The connecting element 15 moves. At some point, the connecting element leaves the second opening 14 of the second element 12. The first element 11 can then be separated from the second element 12. Thus, the temple arm 2 is separated from the frame front 3. The is tool may be magnetized or may have just enough magnetic properties to partially remove the connecting element 15 and then allow it to be withdrawn by gripping it using another tool for example. Alternatively, the tool may be magnetized or have magnetic properties allowing it to magnetically attract the connecting element 15 so as to remove it completely from the openings 13 and 14. The removal tool is able to overcome the magnetic forces that return the connecting element 15 to a position of locking of the temple arm and therefore subsequently of bringing the connecting element 15 into a position of non-locking of the temple arm, allowing dismantling.

The solution is not very bulky and is low in mass. Thanks to the effects of the magnetic forces, the connecting element 15 of the hinge remains housed in the first and second openings 13, 14 even in the event of the pair of spectacles suffering an impact or rough handling.

The risk of inadvertent separation of the connecting element 15 from the frame front 3 is extremely low if not zero. Thus, the connecting element 15 cannot be misplaced, making the hinge-type connection reliable and durable. The solution requires only a small number of parts, making it simple and economical.

Furthermore, the frictional resistance to the movement of the temple arms of spectacles can become more reliable and remain very stable or constant over the course of time. Such is not the case with screw to hinges.

Throughout this document, what is meant by a “magnetic element” is an element exhibiting permanent or non-permanent magnetization. This includes elements that are attracted by a magnet.

Throughout this document, what is meant by “magnetized element” is an element that exhibits permanent magnetization.

Throughout this document, what is meant by “magnet” is a magnet which exhibits permanent magnetization.

1. A fixing device for a spectacles frame, comprising:
a first element having a first opening, the first element being magnetized,
a second element having a second opening, the second element being a magnetic element, and
a connecting element housed in the first opening and in the second opening so as to mechanically connect the first element to the second element the connecting element being a magnetic element.

2. The fixing device according to claim 1, further including that the fixing device is a hinge, the connecting element being a cylindrical or substantially cylindrical shaft and/or the first and second openings are cylindrical or substantially cylindrical orifices so as to allow the first element to pivot relative to the second element.

3. The fixing device according to claim 1, further including that the first element comprises or is a permanent magnet.

4. The fixing device according to claim 1, further including that the first element has an annular shape.

5. The fixing device according to claim 1, further including that the connecting element is a permanent magnet.

6. The fixing device according to claim 1, further including that:
the first element is a frame-front element of a spectacles frame and the second element is a temple-arm element of a spectacles frame, or that
the first element is a temple-arm element of a spectacles frame and in that the second element is a frame-front element of a spectacles frame.

7. A spectacles frame comprising a frame front and at least one temple arm, further including that the at least one temple arm is mechanically connected to the frame front by the fixing device according to claim 1.

8. A pair of spectacles comprising the spectacles frame according to claim 7.

9. A method for assembling or fitting the fixing device according to claim 1, comprising the following steps:
placing the connecting element in the first element,
placing the second element against the first element, the connecting element moving into the second opening under the effect of magnetic forces, when the second opening is positioned in front of the first opening.

10. A method for removing the fixing device according to claim 1, comprising the following steps:
placing a magnetic removal tool on the first element or near the first element so that, under the effect of magnetic forces, the connecting element moves out of the second element,
separating the first element from the second element.

11. The fixing device according to claim 4, wherein the first element has a shape of an annulus of revolution.

12. A pair of spectacles comprising the fixing device according to claim 1.
